(19) United States
(12) Patent Application Publication
(10) Pub. No.: US 2026/0042907 A1
(43) Pub. Date: Feb. 12, 2026

(54) SUPER-PERFORMANCE RUBBER PAD MATERIAL FOR RAILS, PREPARATION METHOD, AND PAD STRUCTURE THEREOF

(71) Applicants: SOUTHWEST JIAOTONG UNIVERSITY, Chengdu (CN); SICHUAN MAITIELONG TECHNOLOGY CO., LTD, Chengdu (CN); ZHEJIANG ZHONGCHUANG ZHIHE RAIL TRANSIT EQUIPMENT CO., LTD., Hangzhou (CN)

(72) Inventors: Caiyou ZHAO, Chengdu (CN); Duojia SHI, Chengdu (CN); Jingmang XU, Chengdu (CN); Ling PANG, Chengdu (CN); Xiaotao WANG, Chengdu (CN); Duoke ZHENG, Hangzhou (CN); Jinbing YANG, Hangzhou (CN); Yannan ZHAO, Chengdu (CN); Junyuan ZHENG, Chengdu (CN); Xin GAO, Chengdu (CN)

(73) Assignees: SOUTHWEST JIAOTONG UNIVERSITY, Chengdu, SC (CN); SICHUAN MAITIELONG TECHNOLOGY CO., LTD, Chengdu, SC (CN); ZHEJIANG ZHONGCHUANG ZHIHE RAIL TRANSIT EQUIPMENT CO., LTD., Hangzhou, ZJ (CN)

(21) Appl. No.: 18/795,236

(22) Filed: Aug. 6, 2024

(51) Int. Cl. C08L 7/00; C08K 3/04; C08K 3/26; C08K 7/10; C08L 15/00; C08L 67/00; C08L 69/00

(52) U.S. Cl. CPC C08L 7/00; C08K 3/041; C08K 3/26; C08K 7/10; C08L 15/00; C08L 67/00; C08L 69/00; C08K 2003/265

(57) ABSTRACT

The invention discloses a super-performance rubber pad material, preparation method, and pad structure for rail, comprising the following components by weight: natural rubber in 20-30 parts, nitrile rubber in 50-70 parts, thermoplastic polyester elastomer in 20-30 parts, modified hollow fiber in 25-30 parts, mesoporous nano-calcium carbonate in 10-30 parts, modified carbon nanotubes in 15-20 parts, polycarbonate in 8-10 parts, petroleum resin in 10-15 parts, vulcanization activator in 2-4 parts, antioxidant in 2-4 parts, vulcanization accelerator in 2-4 parts, vulcanizing agent in 1-3 parts, dispersant in 4-6 parts, and foaming agent in 3-6 parts. The mixture of natural rubber and nitrile rubber provides excellent elasticity and mechanical properties. The addition of thermoplastic polyester elastomer, polycarbonate, and reinforcing fillers greatly improves hardness, tensile strength, and static stiffness, enhancing mechanical properties, preventing compression cracking, and ensuring elasticity and shock absorption performance.

### TECHNICAL FIELD

The invention relates to the technical field of rail transit pad material. Specifically, it relates to a super-performance rubber pad material for rails, a preparation method, and a pad structure thereof.

### BACKGROUND ART

The rubber pad of rail transit is an important part of the track structure, the elastic pad installed between the rail and the concrete sleeper or underground is a combination of the rail and the sleeper elastically, its main function is to buffer the high-speed vibration and impact generated by the train passing through the rail, and to protect the subgrade and sleeper. Therefore, it is necessary to have good vibration reduction performance.

With the development of China's rail transportation industry and the continuous acceleration of the railway, the requirements for vibration reduction and isolation of track operation are becoming more and more strict, it is required that the rubber pad should be improved from the material selection and structure to adapt to the high-speed operation of the vehicle, because the rubber pad needs to be used in the open air for a long time, it is not only required that the rubber pad has excellent shear resistance, good electrical insulation performance, and shock absorption performance but also has good cold resistance, moisture resistance, and climate aging resistance.

Currently, styrene-butadiene rubber or ethylene propylene diene monomer rubber is generally selected as the main material for producing rubber pads, which is mixed with a reinforcing agent (carbon black), vulcanizing agent, antioxidant, and other additives for vulcanization. Although those rubber pads have excellent heat resistance and climate aging resistance, they also have some defects, mainly because the mechanical properties of the rubber pad are poor, easy to be damaged under compression, easy to produce turtle cracks, insufficient elasticity, and poor vibration reduction effect. In addition, carbon black is used as a reinforcing agent in the production process of existing rubber pads, which leads to a decrease in the resistance of finished rubber pads and affects the insulation performance of products.

In addition, the current rail vibration reduction fastener structure of rail transit comprises the upper and lower iron pads and the intermediate rubber pads, in order to ensure the stiffness of the rubber pad surface, the convex point design is generally adopted, in use, due to the gap between the convex points and the convex points on the rubber pad, these gaps form a hollow between the upper and lower iron pads, which can not play a good damping effect, but also produce great noise.

Given this, we hereby come up with this application.

### SUMMARY

The technical problem to be solved by the invention is that the existing rubber pad has poor mechanical properties, easy to be damaged under compression, easily produces turtle cracks, has insufficient elasticity, and poor vibration reduction effect. In addition, carbon black is used as a reinforcing agent in the production process of the existing rubber pad, which leads to a decrease in the resistance of the finished rubber pad and affects the insulation performance of the product. The purpose of this invention is to provide a super-performance rubber pad material for rails, a preparation method, and a pad structure thereof, which can improve the mechanical properties of the rubber pad, avoid compression cracking during use, and ensure the elasticity and shock absorption performance of the pad.

The invention is realized by the following technical scheme:

A super-performance rubber pad material for rails comprises the following components by weight: natural rubber in 20-30 parts, nitrile rubber in 50-70 parts, thermoplastic polyester elastomer in 20-30 parts, modified hollow fiber in 25-30 parts, mesoporous nano-calcium carbonate in 10-30 parts, modified carbon nanotubes in 15-20 parts, polycarbonate in 8-10 parts, petroleum resin in 10-15 parts, vulcanization activator in 2-4 parts, antioxidant in 2-4 parts, vulcanization accelerator in 2-4 parts, vulcanizing agent in 1-3 parts, dispersant in 4-6 parts, foaming agent in 3-6 parts.

The invention uses the mixture of natural rubber and nitrile rubber as the main body of rubber, which combines the excellent elasticity of natural rubber and the excellent mechanical properties of nitrile rubber, at the same time, natural rubber is used as non-polar rubber and nitrile rubber is used as polar rubber, the combination of the two rubbers can improve the damping performance of the material and enhance its damping effect; in addition, the thermoplastic polyester elastomer is introduced into the material formula, so that the rubber elastic pad can have the excellent properties of the foamed elastic pad, so as to improve its strength, at the same time, the low temperature impact stress cracking performance of the elastomer can be improved by adding polycarbonate to improve its cold resistance, finally, the invention greatly improves the hardness, tensile strength, static stiffness and other mechanical properties of the pad through the creative combination of various reinforcing fillers.

Furthermore, comprising the following components by weight: natural rubber in 25 parts, nitrile rubber in 60 parts, thermoplastic polyester elastomer in 30 parts, modified hollow fiber in 25 parts, mesoporous nano-calcium carbonate in 25 parts, modified carbon nanotubes in 15 parts, polycarbonate in 10 parts, petroleum resin in 10 parts, vulcanization activator in 4 parts, antioxidant in 3 parts, vulcanization accelerator in 3 parts, vulcanizing agent in 3 parts, dispersant in 5 parts and foaming agent in 4 parts.

Furthermore, the modified hollow fiber is a hollow fiber filled with modified nano-silica, a preparation method is as follows:
(1) mixing nano-silica powder and hyperbranched polymer according to a certain weight, and kneading in a kneading machine to obtain a modified nano-silica; among them, nano-silica is 85-100 parts, hyperbranched polymer is 2-3 parts;
(2) placing the modified nano-silica obtained by Step (1) and a fiber raw material in an oven respectively, heating and drying to remove residual moisture;
(3) placing a container containing dimethylformamide in a constant temperature water bath, after a temperature is constant, adding the modified nano-silica and polyvinylpyrrolidone, starting a high-speed stirring, and adopting an ultrasonic dispersion, then adding the fiber raw material and stirring for a certain time to obtain a stable and uniform casting solution, then transferring the casting solution to a reactor to reduce the temperature and standing for a certain time; among them, dimethylformamide is 49-63 parts, the modified nano-silica is 5-8 parts, polyvinylpyrrolidone is 2-3 parts, fiber raw material is 30-40 parts;
(4) using a hollow fiber spinning machine, extruding the casting solution from the spinneret by pressure, drying by air, inputting the coagulation bath, and then rinsing and drying to obtain a modified nano-silica filled hollow fiber.

In this invention, the hollow fiber filled with modified nano-silica is used as a reinforcing filler, firstly, the addition of the fiber itself can form mechanical strength with the matrix rubber material to improve the creep resistance of the product, at the same time, the hollow fiber is filled with modified nano-silica. When the pad material is compressed or the tensile strength is too large, the internal hollow fiber is broken, and the internally modified nano-silica can flow out from the hollow fiber to fill the cracks generated by the broken hollow fiber, thereby avoiding cracks, wherein the nano-silica modified by a hyperbranched polymer can make the nano-silica have good fluidity and dispersibility, so the modified nano-silica can be quickly combined with the surrounding matrix material when it flows out from the broken hollow fiber, which effectively avoids the cracking of the product during use, and also avoids the problem of reducing the resistance of the product after adding carbon black.

Furthermore, a preparation method for mesoporous nano-calcium carbonate is as follows:
(1) mixing sodium carbonate solution and polyoxyethylene dehydrated sorbitol monooleate in a certain proportion, and forming a mixed base solution after stirring evenly;
(2) mixing the mixed base solution obtained in Step (1), 25 wt % stearic acid solution and 30 wt % sodium oleate solution in proportion into a mixed liquid, adding sodium pentaphosphate, stirring at a high speed of 1100-1300r/min, and adding calcium chloride solution dropwise during a stirring process, stirring until it forms a uniform emulsion;
(3) separating a solid phase and a filtrate by filtration, and freeze-drying the separated solid phase to obtain mesoporous nano-calcium carbonate.

By adding mesoporous nano-calcium carbonate as a reinforcing material, the adsorption of mesoporous nano-calcium carbonate molecular clusters and high surface activity can form a large number of micro-network structures with modified hollow fibers, and form interactions with other materials to improve the tensile strength of the material; in addition, when the pad material is compressed or the tensile strength is too large, the internal hollow fiber breaks, and the internal modified nano-silica can also be released by the adsorption of mesoporous nano-calcium carbonate molecular clusters to ensure the stability and strength of the micro-network structure.

Furthermore, a preparation method for the modified carbon nanotubes is as follows:
(1) preparation of carbon nanotube layer: coating a uniform carbon nanotube shell on a surface of the carbon nanotube template by microemulsion method to form a carbon nanotube template-carbon nanotube layer core-shell structure.
(2) Preparation of mesoporous silica layer: (1) dispersing nanotubes of the core-shell structure obtained in Step (1) into deionized water, then adding a cationic surfactant, performing an ultrasonic treatment, then adding ammonia water, heating and stirring, and finally adding an appropriate amount of ethyl orthosilicate slowly, after the reaction is completed, obtaining a carbon nanotube template-carbon nanotube layer-mesoporous silica layer core-shell structure by washing and drying.
(3) performing high-temperature calcination, removing the carbon nanotube template, and forming carbon nanotubes with a carbon nanotube layer-mesoporous silica layer structure;
(4) activating the carbon nanotubes with the carbon nanotube layer-mesoporous silica layer structure in 2% methanesulfonic acid solution at 85-95° C. for 3.5-4 h to obtain surface-activated magnetic nanotubes.

In this invention, carbon nanotubes with a carbon nanotube layer-mesoporous silica layer core-shell structure are added as reinforcing materials, on the one hand, carbon nanotubes are hollow structures with open ends, they have a larger specific surface area and good surface activity, which can improve the binding force with other components, at the same time, the strength of carbon nanotubes is high, thus greatly enhancing the strength of the material, on the other hand, the mesoporous silica layer coated on the surface of carbon nanotubes is also activated by methanesulfonic acid solution, so the mesoporous silica layer is rich in a large number of hydroxyl groups, which can form intermolecular hydrogen bonds with polar rubber matrix, hinder the movement of rubber segments, and increase the internal friction of the macromolecule movement, thereby improving the damping performance of the polymer, thereby improving the damping capacity.

Furthermore, the vulcanization activator is stearic acid, and the vulcanizing agent is sulfur.

The invention further provides a preparation method for the super-performance rubber pad material for rails, comprising the following steps:
(1) preparing modified hollow fibers, mesoporous nano-calcium carbonate, and modified carbon nanotubes;
(2) inputting the thermoplastic polyester elastomer into an open mill for thin-pass processing.
(3) inputting the thermoplastic polyester elastomer, natural rubber, and nitrile butadiene rubber treated by Step (1) into a mixing machine and mixing evenly;
(4) adding modified hollow fiber, modified carbon nanotubes, polycarbonate, petroleum resin, stearic acid, antioxidant, and dispersant to the mixing machine in turn, after mixing evenly, placing a mixture at room temperature;
(5) inputting a rubber mix in Step (4) into the mixing machine, adding mesoporous nano-calcium carbonate, vulcanization accelerator, sulfur, foaming agent, maintaining the mixing, mixing evenly after placing to room temperature, and then placing it into a double roller open mill, cutting out films;
(6) inputting the films in a mold for vulcanization molding.

The invention further provides a super-performance rubber pad structure for rails, comprising an upper rubber layer, a middle rubber layer, and a lower rubber layer arranged in turn from top to bottom, the upper rubber layer and the lower rubber layer are made of the rubber pad material in the invention, and the middle rubber layer is made of natural rubber material; the middle rubber layer is a grid structure, and a ratio of a width of the grid frame to a grid gap is 1-1.5:1, the grid gap is filled with reinforced fiber blocks.

Furthermore, the reinforced fiber block is made of nylon or carbon fiber.

Furthermore, a bottom surface of the upper rubber layer is wavy, a surface of the middle rubber layer is wavy embedded with the bottom surface of the upper rubber layer, the bottom surface of the middle rubber layer is wavy, and the surface of the lower rubber layer is wavy embedded with the bottom surface of the middle rubber layer.

The existing elastic pads for rails are usually made of a single and single-layer elastic pad material, which has general shock absorption capacity, strength, and noise elimination ability. The invention creatively sets up a rubber pad structure, comprising three layers of upper, middle, and lower, in which the upper and lower layers adopt the rubber pad material in the invention, and the middle layer adopts the natural rubber. Firstly, the upper and lower rubber pad materials have excellent shock absorption performance, mechanical properties, aging resistance, and high-temperature resistance. Secondly, natural rubber is used in the middle layer, compared with other materials, natural rubber has better elasticity, so it can buffer the vibration between the upper and lower layers, improve the overall flexibility of the pad, and reduce the generation of noise; in addition, the middle rubber layer has a grid structure, and the width of the grid frame to the grid gap is 1-1.5:1, there are reinforced fiber blocks filled in the grid gap, the middle rubber layer has a grid structure, which can make the middle layer have better deformation space when it is squeezed, the setting of reinforced fiber blocks in the gap can provide good support when the middle layer is compressed and improve the strength of the middle layer.

Compared with the existing technology, the invention has the following advantages and beneficial effects:
1. The super-performance rubber pad material for rails provided by the embodiment of the invention adopts the mixture of natural rubber and nitrile rubber as the main body of rubber, which has both the excellent elasticity of natural rubber and the excellent mechanical properties of nitrile rubber, at the same time, natural rubber is used as non-polar rubber and nitrile rubber is used as polar rubber, the combination of the two rubbers can improve the damping performance of the material and enhance its damping effect; in addition, the thermoplastic polyester elastomer is introduced into the material formula, so that the rubber elastic pad can have the excellent properties of the foamed elastic pad, so as to improve its strength, at the same time, the low-temperature impact stress cracking performance of the elastomer can be improved by adding polycarbonate to improve its cold resistance;
2. The super-performance rubber pad material for rails provided by the embodiment of the invention can form a mechanical strength with the matrix rubber material to improve the creep resistance of the product by adding a hollow fiber filled with modified nano-silica as a reinforcing filler, at the same time, the hollow fiber is filled with modified nano-silica. When the pad material is compressed or the tensile strength is too large, the internal hollow fiber is broken, and the internally modified nano-silica can flow out from the hollow fiber to fill the cracks generated by the broken hollow fiber, thereby avoiding cracks;
3. The super-performance rubber pad material for rails provided by the embodiment of the invention, the nano-silica modified by hyperbranched polymer can make the nano-silica have good fluidity and dispersibility, so the modified nano-silica can be quickly combined with the surrounding matrix material when it flows out from the broken hollow fiber, which effectively avoids the cracking of the product during use, and also avoids the problem of reducing the resistance of the product after adding carbon black.
4. The super-performance rubber pad material for rails provided by the embodiment of the invention, by adding mesoporous nano-calcium carbonate as a reinforcing material, the adsorption of mesoporous nano-calcium carbonate molecular clusters and high surface activity can form a large number of micro-network structures with modified hollow fibers, and form interactions with other materials to improve the tensile strength of the material;
5. The super-performance rubber pad material for rails provided by the embodiment of the invention, by adding carbon nanotubes with a carbon nanotube layer-mesoporous silica layer core-shell structure as a reinforcing material, carbon nanotubes are hollow structures with open ends, they have a larger specific surface area and good surface activity, which can improve the binding force with other components, at the same time, the strength of carbon nanotubes is high, thus greatly enhancing the strength of the material;
6. The super-performance rubber pad material for rails provided by the embodiment of the invention, the mesoporous silica layer coated on the surface of carbon nanotubes is also activated by methanesulfonic acid solution, so the mesoporous silica layer is rich in a large number of hydroxyl groups, which can form intermolecular hydrogen bonds with polar rubber matrix, hinder the movement of rubber segments, and increase the internal friction of the macromolecule movement, thereby improving the damping performance of the polymer, thereby improving the damping capacity;
7. The super-performance rubber pad material for rails provided by the embodiment of the invention, the upper and lower layers adopt the rubber pad material in the invention, and the middle layer adopts the natural rubber. Firstly, the upper and lower rubber pad materials have excellent shock absorption performance, mechanical properties, aging resistance, and high-temperature resistance. Secondly, natural rubber is used in the middle layer, compared with other materials, natural rubber has better elasticity, so it can buffer the vibration between the upper and lower layers, improve the overall flexibility of the pad, and reduce the generation of noise; the middle rubber layer has a grid structure, which can make the middle layer have better deformation space when it is squeezed, the setting of reinforced fiber blocks in the gap can provide good support when the middle layer is compressed and improve the strength of the middle layer.

### DETAILED DESCRIPTION OF THE EMBODIMENTS

In order to make the purpose, technical scheme, and advantages of the invention more clear, the following is a further detailed description of the invention in combination with the embodiments, the schematic implementation methods, and the explanation of the invention are only used to explain the invention and are not used as a limitation of the invention.

In the following description, a large number of specific details are described to provide a thorough understanding of the invention. However, it is obvious to ordinary technicians in this field that these specific details are not necessary to implement the invention. In other embodiments, in order to avoid confusion with the invention, the method of notifying is not specifically described.

Throughout the specification, references to ‘an embodiment’, ‘embodiment’, ‘an example’, or ‘example’ mean that a particular feature, structure, or characteristic described in conjunction with the embodiment or example is comprised in at least one embodiment of the invention. Therefore, the phrases ‘an embodiment’, ‘embodiment’, ‘an example’, or ‘example’ appearing in various places throughout the specification do not necessarily refer to the same embodiment or example. In addition, a particular feature, structure, or feature can be combined in one or more embodiments or examples with any appropriate combination and/or sub-combination.

### Embodiment 1

The embodiment of the invention provides a preparation method for a super-performance rubber pad material for rails, which comprises the following steps:
(1) Preparation of modified nano-silica filled hollow fiber: The nano-silica powder and hyperbranched polymer are mixed according to a certain weight, and kneaded in a kneading machine to obtain modified nano-silica, wherein the nano-silica is 85-100 parts, hyperbranched polymer is 2-3 parts; the obtained modified nano-silica and fiber raw material is placed in an oven, heated and dried to remove residual moisture; the container containing dimethylformamide is placed in a constant temperature water bath, after the temperature is constant, the modified nano-silica and polyvinylpyrrolidone are added, the high-speed stirring is turned on, and the ultrasonic dispersion is used, and then the fiber raw material is added and stirred for a certain time to obtain a stable and uniform casting solution, then the casting solution is transferred to the reactor to reduce the temperature and stand for a certain time; wherein dimethylformamide is 49-63 parts, the modified nano-silica is 5-8 parts, polyvinylpyrrolidone is 2-3 parts, fiber raw material is 30-40 parts; the hollow fiber spinning machine is adopted, the casting solution is extruded from the spinneret by pressure, after dried by air, it is input into the coagulation bath, and then rinsed and dried to obtain a modified nano-silica filled hollow fiber;
(2) preparation of mesoporous nano-calcium carbonate: The sodium carbonate solution and polyoxyethylene dehydrated sorbitol monooleate are mixed in a certain proportion and stirred evenly to form a mixed base solution. The obtained mixed base solution, 25 wt % stearic acid solution and 30 wt % sodium oleate solution are mixed in proportion to prepare a mixed solution, and pentasodium triphosphate is added for high-speed stirring at 1100-1300r/min, calcium chloride solution is added dropwise during the stirring process, and stirred until it forms a uniform emulsion; the solid phase and filtrate are separated by filtration, and the separated solid phase is freeze-dried to obtain mesoporous nano-calcium carbonate;
(3) preparation of the modified carbon nanotubes: A uniform carbon nanotube shell is coated on the surface of the carbon nanotube template by microemulsion method to form a carbon nanotube template-carbon nanotube layer core-shell structure; the obtained core-shell nanotubes are dispersed in deionized water, and then cationic surfactants are added for ultrasonic treatment, then ammonia water is added, heated and stirred, and finally, an appropriate amount of tetraethyl orthosilicate is slowly added dropwise, after the reaction is completed, it is washed and dried to obtain a carbon nanotube template-carbon nanotube layer-mesoporous silica layer core-shell structure; a high temperature calcination is performed, the carbon nanotube template is removed, the formation carbon nanotubes with the carbon nanotube layer-mesoporous silica layer structure; the carbon nanotubes with carbon nanotube layer-mesoporous silica layer structure are activated in 2% methanesulfonic acid solution at 85-95° C. for 3.5-4 h to obtain surface-activated magnetic nanotubes;
(4) the thermoplastic polyester elastomer is put into the open mill for thin-pass processing;
(5) the treated thermoplastic polyester elastomer, natural rubber, and nitrile rubber are put into the mixing machine for mixing uniformly;
(6) the modified hollow fiber, modified carbon nanotubes, polycarbonate, petroleum resin, stearic acid, antioxidant, and dispersant are added to the mixing machine in turn, after mixing evenly, the mixture is placed at room temperature;
(7) the rubber mix in Step (6) is input into the mixing machine, mesoporous nano-calcium carbonate, vulcanization accelerator, sulfur, and foaming agent are added, continue to mix and mix evenly after it is placed to room temperature, and then it is input into the double roller open mill and cut out films;
(8) the films are input into the mold for vulcanization molding;
among them, natural rubber is 25 parts, nitrile rubber is 60 parts, thermoplastic polyester elastomer is 30 parts, modified hollow fiber is 25 parts, mesoporous nano-calcium carbonate is 25 parts, modified carbon nanotubes is 15 parts, polycarbonate is 10 parts, petroleum resin is 10 parts, stearic acid is 4 parts, antioxidant is 3 parts, vulcanization accelerator is 3 parts, sulfur is 3 parts, the dispersant is 5 parts and the foaming agent is 4 parts.

### Embodiment 2

The embodiment of the invention is a preparation method for a super-performance rubber pad material for rails, which comprises the following steps:
(1) Preparation of modified nano-silica filled hollow fiber: The nano-silica powder and hyperbranched polymer are mixed according to a certain weight, and kneaded in a kneading machine to obtain modified nano-silica, wherein the nano-silica is 85 parts, hyperbranched polymer is 2 parts; the obtained modified nano-silica and fiber raw material is placed in an oven, heated and dried to remove residual moisture; the container containing dimethylformamide is placed in a constant temperature water bath, after the temperature is constant, the modified nano-silica and polyvinylpyrrolidone are added, the high-speed stirring is turned on, and the ultrasonic dispersion is used, and then the fiber raw material is added and stirred for a certain time to obtain a stable and uniform casting solution, then the casting solution is transferred to the reactor to reduce the temperature and stand for a certain time; wherein dimethylformamide is 49 parts, the modified nano-silica is 5 parts, polyvinylpyrrolidone is 2 parts, the fiber raw material is 30 parts; the hollow fiber spinning machine is adopted, the casting solution is extruded from the spinneret by pressure, after dried by air, it is input into the coagulation bath, and then rinsed and dried to obtain a modified nano-silica filled hollow fiber;
(2) preparation of mesoporous nano-calcium carbonate: The sodium carbonate solution and polyoxyethylene dehydrated sorbitol monooleate are mixed in a certain proportion and stirred evenly to form a mixed base solution. The obtained mixed base solution, 25 wt % stearic acid solution and 30 wt % sodium oleate solution are mixed in proportion to prepare a mixed solution, and pentasodium triphosphate is added for high-speed stirring at 1100-1300r/min, calcium chloride solution is added dropwise during the stirring process, and stirred until it forms a uniform emulsion; the solid phase and filtrate are separated by filtration, and the separated solid phase is freeze-dried to obtain mesoporous nano-calcium carbonate;
(3) preparation of the modified carbon nanotubes: A uniform carbon nanotube shell is coated on the surface of the carbon nanotube template by microemulsion method to form a carbon nanotube template-carbon nanotube layer core-shell structure; the obtained core-shell nanotubes are dispersed in deionized water, and then cationic surfactants are added for ultrasonic treatment, then ammonia water is added, heated and stirred, and finally, an appropriate amount of tetraethyl orthosilicate is slowly added dropwise, after the reaction is completed, it is washed and dried to obtain a carbon nanotube template-carbon nanotube layer-mesoporous silica layer core-shell structure; a high temperature calcination is performed, the carbon nanotube template is removed, the formation carbon nanotubes with the carbon nanotube layer-mesoporous silica layer structure; the carbon nanotubes with carbon nanotube layer-mesoporous silica layer structure are activated in 2% methanesulfonic acid solution at 85-95° C. for 3.5-4 h to obtain surface-activated magnetic nanotubes;
(4) the thermoplastic polyester elastomer is put into the open mill for thin-pass processing;
(5) the treated thermoplastic polyester elastomer, natural rubber, and nitrile rubber are put into the mixing machine for mixing uniformly;
(6) the modified hollow fiber, modified carbon nanotubes, polycarbonate, petroleum resin, stearic acid, antioxidant, and dispersant are added to the mixing machine in turn, after mixing evenly, the mixture is placed at room temperature;
(7) the rubber mix in Step (6) is input into the mixing machine, mesoporous nano-calcium carbonate, vulcanization accelerator, sulfur, and foaming agent are added, continue to mix and mix evenly after it is placed to room temperature, and then it is input into the double roller open mill and cut out films;
(8) the films are input into the mold for vulcanization molding;
among them, natural rubber is 20 parts, nitrile rubber is 50 parts, thermoplastic polyester elastomer is 20 parts, modified hollow fiber is 25 parts, mesoporous nano-calcium carbonate is 10 parts, modified carbon nanotubes is 15 parts, polycarbonate is 8 parts, petroleum resin is 10 parts, stearic acid is 2 parts, antioxidant is 2 parts, vulcanization accelerator is 2 parts, sulfur is 1 part, the dispersant is 4 parts and the foaming agent is 3 parts.

### Embodiment 3

The embodiment of the invention is a preparation method for a super-performance rubber pad material for rails, which comprises the following steps:
(1) Preparation of modified nano-silica filled hollow fiber: The nano-silica powder and hyperbranched polymer are mixed according to a certain weight, and kneaded in a kneading machine to obtain modified nano-silica, wherein the nano-silica is 100 parts, hyperbranched polymer is 3 parts; the obtained modified nano-silica and fiber raw material is placed in an oven, heated and dried to remove residual moisture; the container containing dimethylformamide is placed in a constant temperature water bath, after the temperature is constant, the modified nano-silica and polyvinylpyrrolidone are added, the high-speed stirring is turned on, and the ultrasonic dispersion is used, and then the fiber raw material is added and stirred for a certain time to obtain a stable and uniform casting solution, then the casting solution is transferred to the reactor to reduce the temperature and stand for a certain time; wherein dimethylformamide is 63 parts, the modified nano-silica is 8 parts, polyvinylpyrrolidone is 3 parts, the fiber raw material is 40 parts; the hollow fiber spinning machine is adopted, the casting solution is extruded from the spinneret by pressure, after dried by air, it is input into the coagulation bath, and then rinsed and dried to obtain a modified nano-silica filled hollow fiber;
(2) preparation of mesoporous nano-calcium carbonate: The sodium carbonate solution and polyoxyethylene dehydrated sorbitol monooleate are mixed in a certain proportion and stirred evenly to form a mixed base solution. The obtained mixed base solution, 25 wt % stearic acid solution and 30 wt % sodium oleate solution are mixed in proportion to prepare a mixed solution, and pentasodium triphosphate is added for high-speed stirring at 1100-1300r/min, calcium chloride solution is added dropwise during the stirring process, and stirred until it forms a uniform emulsion; the solid phase and filtrate are separated by filtration, and the separated solid phase is freeze-dried to obtain mesoporous nano-calcium carbonate;
(3) preparation of the modified carbon nanotubes: A uniform carbon nanotube shell is coated on the surface of the carbon nanotube template by microemulsion method to form a carbon nanotube template-carbon nanotube layer core-shell structure; the obtained core-shell nanotubes are dispersed in deionized water, and then cationic surfactants are added for ultrasonic treatment, then ammonia water is added, heated and stirred, and finally, an appropriate amount of tetraethyl orthosilicate is slowly added dropwise, after the reaction is completed, it is washed and dried to obtain a carbon nanotube template-carbon nanotube layer-mesoporous silica layer core-shell structure; a high temperature calcination is performed, the carbon nanotube template is removed, the formation carbon nanotubes with the carbon nanotube layer-mesoporous silica layer structure; the carbon nanotubes with carbon nanotube layer-mesoporous silica layer structure are activated in 2% methanesulfonic acid solution at 85-95° C. for 3.5-4 h to obtain surface-activated magnetic nanotubes;
(4) the thermoplastic polyester elastomer is put into the open mill for thin-pass processing;
(5) the treated thermoplastic polyester elastomer, natural rubber, and nitrile rubber are put into the mixing machine for mixing uniformly;
(6) the modified hollow fiber, modified carbon nanotubes, polycarbonate, petroleum resin, stearic acid, antioxidant, and dispersant are added to the mixing machine in turn, after mixing evenly, the mixture is placed at room temperature;
(7) the rubber mix in Step (6) is input into the mixing machine, mesoporous nano-calcium carbonate, vulcanization accelerator, sulfur, and foaming agent are added, continue to mix and mix evenly after it is placed to room temperature, and then it is input into the double roller open mill and cut out films;
(8) the films are input into the mold for vulcanization molding;
among them, natural rubber is 30 parts, nitrile rubber is 70 parts, thermoplastic polyester elastomer is 30 parts, modified hollow fiber is 30 parts, mesoporous nano-calcium carbonate is 30 parts, modified carbon nanotubes is 20 parts, polycarbonate is 10 parts, petroleum resin is 15 parts, stearic acid is 4 parts, antioxidant is 24 parts, vulcanization accelerator is 4 parts, sulfur is 3 parts, the dispersant is 6 parts and the foaming agent is 6 parts.

### Comparison Case 1

The difference between this comparison case and Embodiment 1 is that no modified hollow fiber, mesoporous nano-calcium carbonate, and modified carbon nanotubes are added.

### Comparison Case 2

The difference between this comparison case and Embodiment 1 is that no modified hollow fiber and mesoporous nano-calcium carbonate are added.

### Comparison Case 3

The difference between this comparison case and Embodiment 1 is that no modified carbon nanotubes are added.

### Comparison Case 4

The difference between this comparison case and Embodiment 1 is that no thermoplastic polyester elastomer is added.

### Comparison Case 5

The difference between this comparison case and Embodiment 1 is that it does not contain nitrile rubber and only contains 85 parts natural rubbers.

### Comparison Case 6

The difference between this comparison case and Embodiment 1 is that it does not contain natural rubber and only contains 85 parts nitrile rubbers.

| | | Embodiment | Embodiment | Embodiment | Comparison |
|---|---|---|---|---|---|
| Test items | Standard | 1 | 2 | 3 | case 1 |
| Hardness (Shore A) | GB/T531 | 73 | 71 | 72 | 51 |
| (degree) | | | | | |
| Akron abrasion | GB/T1689 | 0.31 | 0.31 | 0.32 | 0.55 |
| (cm³/1.61 km) | | | | | |
| Tensile | GB/T528 | 30.2 | 28.9 | 29.4 | 17.9 |
| strength(MPa) | | | | | |
| Breaking | GB/T528 | 710 | 690 | 705 | 498 |
| elongation(%) | | | | | |
| Hot air aging | GB/T3512 | 25.6 | 24.6 | 23.9 | 11.2 |
| tensile | | | | | |
| strength(100° C., 72 | | | | | |
| h)(MPa) | | | | | |
| Hot air aging | GB/T528 | 623 | 609 | 612 | 320 |
| breaking | | | | | |
| elongation(100° C., | | | | | |
| 72 h)(%) | | | | | |
| 200% stretching | GB/T528 | 13.3 | 13.8 | 14.1 | 6.8 |
| stress (MPa) | | | | | |
| Compression | GB/T7759 | 9.4 | 9.8 | 9.7 | 22 |
| permanent | | | | | |
| deformation | | | | | |
| (compression | | | | | |
| ratio | | | | | |
| 30%, 100° C. × 72 h) | | | | | |
| (%) | | | | | |
| Static stiffness | TB/T2626 | 82 | 79 | 84 | 75 |
| (kN/mm) | | | | | |
| Operating | TB/T1495 | 5.2 × 10¹⁰ | 5.1 × 10¹⁰ | 5.1 × 10¹⁰ | 3.9 × 10¹⁰ |
| refinery | | | | | |
| resistance(Ω) | | | | | |
| Damping | GB/T18258-2000 | 0.85 | 0.83 | 0.79 | 0.72 |
| coefficient (30° C.) | | | | | |
| | Comparison | Comparison | Comparison | Comparison | Comparison |
| Test items | case 2 | case 3 | case 4 | case 5 | case 6 |
| Hardness (Shore A) | 62 | 65 | 66 | 60 | 67 |
| (degree) | | | | | |
| Akron abrasion | 0.49 | 0.47 | 0.43 | 0.40 | 0.39 |
| (cm³/1.61 km) | | | | | |
| Tensile | 24.1 | 25.7 | 26.9 | 25.4 | 27.6 |
| strength(MPa) | | | | | |
| Breaking | 533 | 525 | 658 | 664 | 679 |
| elongation(%) | | | | | |
| Hot air aging | 13.3 | 14.4 | 18.4 | 17.6 | 21.9 |
| tensile | | | | | |
| strength(100° C., 72 | | | | | |
| h)(MPa) | | | | | |
| Hot air aging | 397 | 415 | 506 | 521 | 587 |
| breaking | | | | | |
| elongation(100° C., | | | | | |
| 72 h)(%) | | | | | |
| 200% stretching | 7.2 | 7.6 | 9.8 | 11.3 | 12.1 |
| stress (MPa) | | | | | |
| Compression | 19.8 | 18.5 | 17.6 | 16.5 | 17.3 |
| permanent | | | | | |
| deformation | | | | | |
| (compression | | | | | |
| ratio | | | | | |
| 30%, 100° C. × 72 h) | | | | | |
| (%) | | | | | |
| Static stiffness | 73 | 77 | 79 | 82 | 78 |
| (kN/mm) | | | | | |
| Operating | 3.7 × 10¹⁰ | 3.6 × 10¹⁰ | 4.2 × 10¹⁰ | 4.3 × 10¹⁰ | 4.0 × 10¹⁰ |
| refinery | | | | | |
| resistance(Ω) | | | | | |
| Damping | 0.71 | 0.69 | 0.74 | 0.45 | 0.62 |
| coefficient (30° C.) | | | | | |

### Embodiment 4

A super-performance rubber pad structure for rails in this embodiment, comprising an upper rubber layer, a middle rubber layer, and a lower rubber layer arranged in turn from top to bottom, the upper rubber layer and the lower rubber layer are made of the rubber pad material in the invention, and the middle rubber layer is made of natural rubber material; the middle rubber layer is a grid structure, and the ratio of the width of the grid frame to the grid gap is 1-1.5:1, the grid gap is filled with reinforced fiber blocks, the reinforced fiber block is made of nylon or carbon fiber, the bottom surface of the upper rubber layer is wavy, the surface of the middle rubber layer is wavily embedded with the bottom surface of the upper rubber layer, the bottom surface of the middle rubber layer is wavy, and the surface of the lower rubber layer is wavily embedded with the bottom surface of the middle rubber layer.

The existing elastic pads for rails are usually made of a single and single-layer elastic pad material, which has general damping capacity, strength, and noise elimination ability. The invention creatively sets up a rubber pad structure, comprising three layers of upper, middle, and lower, in which the upper and lower layers adopt the rubber pad material in the invention, and the middle layer adopts the natural rubber. Firstly, the upper and lower rubber pad materials have excellent shock absorption performance, mechanical properties, aging resistance, and high-temperature resistance. Secondly, natural rubber is used in the middle layer, compared with other materials, natural rubber has better elasticity, so it can buffer the vibration between the upper and lower layers, improve the overall flexibility of the pad, and reduce the generation of noise; in addition, the middle rubber layer has a grid structure, and the width of the grid frame to the grid gap is 1-1.5:1, there are reinforced fiber blocks filled in the grid gap, the middle rubber layer has a grid structure, which can make the middle layer have better deformation space when it is squeezed, the setting of reinforced fiber blocks in the gap can provide good support when the middle layer is compressed and improve the strength of the middle layer.

The specific implementation methods described above further explain the purpose, technical scheme, and beneficial effects of the invention. It should be understood that the above is only the specific embodiment of the invention, and is not used to limit the protection scope of the invention. Any modification, equivalent replacement, improvement, etc. made within the spirit and principles of the invention should be included in the protection scope of the invention.

What is claimed is:

1. A super-performance rubber pad material for rails comprises the following components by weight: natural rubber in 20-30 parts, nitrile rubber in 50-70 parts, thermoplastic polyester elastomer in 20-30 parts, modified hollow fiber in 25-30 parts, mesoporous nano-calcium carbonate in 10-30 parts, modified carbon nanotubes in 15-20 parts, polycarbonate in 8-10 parts, petroleum resin in 10-15 parts, vulcanization activator in 2-4 parts, antioxidant in 2-4 parts, vulcanization accelerator in 2-4 parts, vulcanizing agent in 1-3 parts, dispersant in 4-6 parts, foaming agent in 3-6 parts;
wherein the modified hollow fiber is a hollow fiber filled with modified nano-silica, a preparation method is as follows:
(1) mixing nano-silica powder and hyperbranched polymer according to a certain weight, and kneading in a kneading machine to obtain a modified nano-silica; among them, nano-silica is 85-100 parts, hyperbranched polymer is 2-3 parts;
(2) placing the modified nano-silica obtained by Step (1) and a fiber raw material in an oven respectively, heating and drying to remove residual moisture;
(3) placing a container containing dimethylformamide in a constant temperature water bath, after a temperature is constant, adding the modified nano-silica and polyvinylpyrrolidone, starting a high-speed stirring, and adopting an ultrasonic dispersion, then adding the fiber raw material and stirring for a certain time to obtain a stable and uniform casting solution, then transferring the casting solution to a reactor to reduce the temperature and standing for a certain time; among them, dimethylformamide is 49-63 parts, the modified nano-silica is 5-8 parts, polyvinylpyrrolidone is 2-3 parts, fiber raw material is 30-40 parts;
using a hollow fiber spinning machine, extruding the casting solution from the spinneret by pressure, drying by air, inputting the coagulation bath, and then rinsing and drying to obtain a modified nano-silica filled hollow fiber;
wherein a preparation method for mesoporous nano-calcium carbonate is as follows:
(1) mixing sodium carbonate solution and polyoxyethylene dehydrated sorbitol monooleate in a certain proportion, and forming a mixed base solution after stirring evenly;
(2) mixing the mixed base solution obtained in Step (1), 25 wt % stearic acid solution and 30 wt % sodium oleate solution in proportion into a mixed liquid, adding sodium pentaphosphate, stirring at a high speed of 1100-1300r/min, and adding calcium chloride solution dropwise during a stirring process, stirring until it forms a uniform emulsion;
(3) separating a solid phase and a filtrate by filtration, and freeze-drying the separated solid phase to obtain mesoporous nano-calcium carbonate;
wherein a preparation method for the modified carbon nanotubes is as follows:
(1) preparation of carbon nanotube layer: coating a uniform carbon nanotube shell on a surface of the carbon nanotube template by microemulsion method to form a carbon nanotube template-carbon nanotube layer core-shell structure.
(2) preparation of mesoporous silica layer: (1) dispersing nanotubes of the core-shell structure obtained in Step (1) into deionized water, then adding a cationic surfactant, performing an ultrasonic treatment, then adding ammonia water, heating and stirring, and finally adding an appropriate amount of ethyl orthosilicate slowly, after the reaction is completed, obtaining a carbon nanotube template-carbon nanotube layer-mesoporous silica layer core-shell structure by washing and drying.
(3) performing high-temperature calcination, removing the carbon nanotube template, and forming carbon nanotubes with a carbon nanotube layer-mesoporous silica layer structure.

2. The super-performance rubber pad material for rails according to claim 1, wherein it comprises the following components by weight: natural rubber in 25 parts, nitrile rubber in 60 parts, thermoplastic polyester elastomer in 30 parts, modified hollow fiber in 25 parts, mesoporous nano-calcium carbonate in 25 parts, modified carbon nanotubes in 15 parts, polycarbonate in 10 parts, petroleum resin in 10 parts, vulcanization activator in 4 parts, antioxidant in 3 parts, vulcanization accelerator in 3 parts, vulcanizing agent in 3 parts, dispersant in 5 parts and foaming agent in 4 parts.

3. The super-performance rubber pad material for rails according to claim 1, wherein the vulcanization activator is stearic acid, and the vulcanizing agent is sulfur.

4. A preparation method for the super-performance rubber pad material for rails according to claim 1, comprising the following steps:
(1) preparing modified hollow fibers, mesoporous nano-calcium carbonate, and modified carbon nanotubes;
(2) inputting the thermoplastic polyester elastomer into an open mill for thin-pass processing;
(3) inputting the thermoplastic polyester elastomer, natural rubber, and nitrile butadiene rubber treated by Step (1) into a mixing machine and mixing evenly;
(4) adding modified hollow fiber, modified carbon nanotubes, polycarbonate, petroleum resin, stearic acid, antioxidant, and dispersant to the mixing machine in turn, after mixing evenly, placing a mixture at room temperature;
(5) inputting a rubber mix in Step (4) into the mixing machine, adding mesoporous nano-calcium carbonate, vulcanization accelerator, sulfur, foaming agent, maintaining the mixing, mixing evenly after placing to room temperature, and then placing it into a double roller open mill, cutting out films; and
(6) inputting the films in a mold for vulcanization molding.

5. A super-performance rubber pad structure for rails, comprising an upper rubber layer, a middle rubber layer, and a lower rubber layer arranged in turn from top to bottom, the upper rubber layer and the lower rubber layer are made of the rubber pad material according to claim 1, and the middle rubber layer is made of natural rubber material; the middle rubber layer is a grid structure, and a ratio of a width of the grid frame to a grid gap is 1-1.5:1, the grid gap is filled with reinforced fiber blocks.

6. The super-performance rubber pad structure for rails according to claim 5, wherein the reinforced fiber block is made of nylon or carbon fiber.

7. The super-performance rubber pad structure for rails according to claim 5, wherein a bottom surface of the upper rubber layer is wavy, a surface of the middle rubber layer is wavy embedded with the bottom surface of the upper rubber layer, the bottom surface of the middle rubber layer is wavy, and the surface of the lower rubber layer is wavy embedded with the bottom surface of the middle rubber layer.
